(19) United States
(12) Patent Application Publication
(10) Pub. No.: US 2024/0281289 A1
(43) Pub. Date: Aug. 22, 2024

(54) OPERATION DECOMPOSITION USING EDGE DEVICES

(71) Applicant: Micron Technology, Inc., Boise, ID (US)

(72) Inventors: Pavana Prakash, Houston, TX (US); Shashank Bangalore Lakshman, Folsom, CA (US); Febin Sunny, Folsom, CA (US); Saideep Tiku, Fort Collins, CO (US); Poorna Kale, Folsom, CA (US)

(21) Appl. No.: 18/436,881

(22) Filed: Feb. 8, 2024

Related U.S. Application Data
(60) Provisional application No. 63/446,443, filed on Feb. 17, 2023.

(51) Int. Cl. G06F 9/50

(52) U.S. Cl. CPC G06F 9/5027

(57) ABSTRACT

Decomposing an operation can include dividing the operation into a plurality of portions of the operation. A different portion can be provided from the plurality of portions to each group from the plurality of groups of edge devices. The input values can be provided to each of the plurality of groups of edge devices. A plurality of outputs can be received from the plurality of groups of edge devices generated using the input values and the plurality of portions. The plurality of outputs can be recomposed into a single output for the operation.

### PRIORITY INFORMATION

This Application claims the benefit of U.S. Provisional Application No. 63/446,443, filed on Feb. 17, 2023, the contents of which are incorporated herein by reference.

### TECHNICAL FIELD

The present disclosure relates generally to apparatuses, non-transitory machine-readable media, and methods associated with decomposing operations using edge devices.

### BACKGROUND

A computing device can be, for example, a personal laptop computer, a desktop computer, a smart phone, smart glasses, a tablet, a wrist-worn device, a mobile device, a digital camera, and/or redundant combinations thereof, among other types of computing devices.

Computing devices can be used to perform operations. Performing operations can utilize resources of the computing devices. Performing operations can utilize memory resources, processing resources, and power resources, for example.

### BRIEF DESCRIPTION OF THE DRAWINGS

FIG. 1 illustrates example computing systems for decomposing operations in accordance with some embodiments of the present disclosure.

FIG. 2 illustrates a block diagram for decomposing operations in accordance with some embodiments of the present disclosure.

FIG. 3 is a flow diagram corresponding to a method for decomposing operations in accordance with some embodiments of the present disclosure.

FIG. 4 is a block diagram of an example computer system in which embodiments of the present disclosure may operate.

### DETAILED DESCRIPTION

Apparatuses, machine-readable media, and methods related to decomposing operations using edge devices. In various instances, an operation can be decomposed into a plurality of portions. A different portion from the plurality of portions can be provided to each group from a plurality of groups of edge devices. Input values can also be provided to each of the plurality of groups of edge devices. A plurality of outputs can also be received from the plurality of groups of edge devices. The plurality of outputs can be generated using the input values and the plurality of portions. The plurality of outputs can be recomposed into a single output for the operation. As used herein, decomposing describes the dividing of an operation while recomposing describes the combining/aggregating of multiple outputs into a single output.

As used herein, an operation can include logical operations, mathematical operations, and/or machine learning operations. For example, an operation can include an artificial neural network. The operation (e.g., the ANN) can provide learning by forming probability weight associations between an input and an output. The probability weight associations can be provided by a plurality of nodes that comprise the ANN. The nodes together with weights, biases, and/or activation functions can be used to generate an output of the ANN based on the input to the ANN. A plurality of nodes of the ANN can be grouped to form layers of the ANN.

Mathematical operations can include, for example, matrix multiplication. As the size of the matrices grows the resourced utilized to perform matrix multiplication operations can also increase. The inputs to a matrix multiplication operation may be large enough that it may become impractical to perform matrix multiplication utilizing a single computing device. Even in situation where the inputs to a matrix multiplication operation are small enough that the matrix multiplication operation can be performed by a single computing device, the duration of time utilized to perform the matrix multiplication may be longer than is practical.

Aspects of the present disclosure address the above and other deficiencies by decomposing an operation utilizing edge devices. As used herein, an edge device describes a device that has processing capabilities and that connects and/or exchanges data with other devices and systems over a communications network. For example, edge devices can include internet of thing (IOT) devices and/or user equipment (UE). A UE can include hand-held devices such as a hand-held telephone and/or a laptop computer equipped with a mobile broadband adapter, among other possible devices. IOT devices can include devices that comprise sensors and which can exchange data collected from said sensors. IOT devices can include smart home devices such as thermostats and doorbells and/or wearable devices such as smart watches, among other possible IOT devices. Edge devices can also include drones, for example.

In various instances, edge devices can be utilized to implement federated learning. Federated learning describes the training of an algorithm using multiple decentralized edge devices. In various examples, each of the edge devices can receive a different portion of an operation. The edge devices can also receive a data set from a centralized server. The data set and the different portions of the operation can be utilized by the edge devices to generate an output for the operation.

The processing resources and/or memory resources of the edge devices can be repurposed and utilized to perform the operation. To deploy the operation on edge devices, a task graph associated with the operation can be divided in such a way that edge devices are contractually obligated or monetarily incentivized to perform a small portion of the operation using their local computational resources. As used herein, a task graph is a graphical representation of the portions (e.g., sub-operations) that are performed to perform the operation. For example, the task graph can be a graphical representation of the forward propagation paths and/or backward propagation paths through which activation signals are passed between edge devices and can represent the processing operations performed by the edge devices in implementing a forward propagation of the ANN model and/or a backward propagation of the ANN model. A central server can divide a dataset into batches and can share the dataset with the edge devices. The edge devices can perform the operations using their local computational resources. The results generated by the edge devices can be uploaded to the central server.

The central server can compose (e.g., recompose) the received results to generate a single result for the operation. For example, the central server can receive multiple outputs from a single group from the plurality of groups of edge devices. The central server can aggregate the outputs received from the edge devices in a group to generate a portion of the output of the operation. The central server can then compose the portions of the output of the operation into a single output. The central server can utilize the single output to perform further operations, can store the single output, and/or can provide the single output to a user or a different computing device.

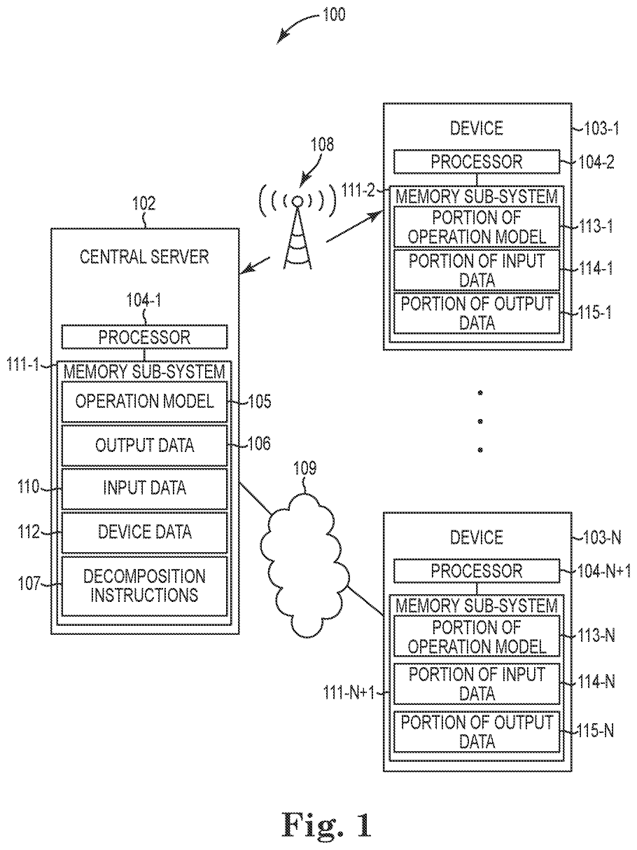

FIG. 1 illustrates example computing system 100 for decomposing operations in accordance with some embodiments of the present disclosure. The computing system 100 can comprise a central server 102 and edge devices 103-1, 103-N (e.g., devices 103-1, 103-N), referred to herein as edge devices 103.

The computing system 100, the central server 102, and the edge devices 103 can comprise hardware, firmware, and/or software configured to perform an operation to generate an output. The central server 102 and the edge devices 103 can further include memory sub-systems 111-1, 111-2, 111-N+1(e.g., a non-transitory MRM), referred to herein as memory sub-systems 111, on which may be stored instructions (e.g., decomposition instructions 107) and/or data (e.g., output data 106, input data 110, device data 112). Although the following description refers to a processing device and a memory device, the description may also apply to a system with multiple processing devices and multiple memory devices. In such examples, the instructions may be distributed across (e.g., stored by) multiple memory devices and the instructions may be distributed across (e.g., executed by) multiple processing devices.

The memory sub-systems 111 may comprise memory devices. The memory devices may be electronic, magnetic, optical, or other physical storage device that stores executable instructions. One or both of the memory devices may be, for example, non-volatile or volatile memory. In some examples, one or both of the memory device is a non-transitory MRM comprising RAM, an Electrically-Erasable Programmable ROM (EEPROM), a storage drive, an optical disc, and the like. The memory sub-systems 111 may be disposed within a controller, the central server 102, and/or the edge devices 103. In this example, the operation model 105 can be “installed” on the central server 102. The memory sub-systems 111 can be portable, external or remote storage mediums, for example, that allow the central server 102 and/or the edge devices 103 to download the operating model 105 from the portable/external/remote storage mediums. In this situation, the operation model 105 may be part of an “installation package.” As described herein, the memory sub-systems 111 can be encoded with executable instructions (e.g., decomposition instructions 107) for decomposing (e.g., dividing) the operation, dividing the edge devices 103 into groups, and recomposing the output data received from the edge devices 103.

The central server 102 can execute the decomposition instructions 107 using the processor 104-1 also referred to herein as processing device 104-1. The decomposition instructions 107 can be stored in the memory sub-system 111-1 prior to being executed by the processing device 104-1. The execution of the decomposition instructions 107 can cause the operation model 105 to be provided to the edge devices 103. As used herein, the operation model 105 is a representation of an operation. For example, the operation model 105 can describe sub-operations that comprise the operation. The operation model 105 can describe variables that are utilized to perform the operation. For example, the operation model 105 can describe a matrix-matrix multiplication operation or a max pooling operation (e.g., operation that calculates the maximum value for patches of a matrix and create a downsampled matrix).

For example, the central server 102 can divide the operation model 105 into multiple portions 113-1, 113-N, referred to as portions 113. Each of the portions 113 of the operation model 105 can correspond to sub-operations of the operation. For example, if the operation model 105 describes a 10×10 matrix multiplication operation, then the portions 113 can describe four 5×5 matrix multiplication operations. In various instances, each of the sub-operations can be divided further into additional sub-operations. The central server 102 can provide the portions 113 of the operation model 105 and the input data 110 to the edge devices 103 utilizing a wireless network 108 and/or a physical network 109.

The edge devices 103 can store the portions 113 and the portions of the input data 114. The edge devices 103, comprising the processors 104-2, 104-N+1, can execute the portions 113 of the operation model 105 utilizing the processors 104-2, 104-N+1 to generate portions of output data 115-1, 115-N, referred to as portions of output data 115. The portions of the output data 115 can be stored in the memory sub-systems 111-2, 111-N+1 of the edge devices 103. The portions of the output data 115 can be provided to the central server 102. The central server 102 can compose the portions of the output data 115 to generate the output data 106.

The central server 102 can execute the decomposition instructions 107, using the processor 104-1, to decompose the operation model 105 and provide the decomposed operation model 105 to the edge device 103 to generate output data 106. Although the decomposition instructions 107 are shown as software in FIG. 1, the decomposition instructions 107 can be encoded in a computer readable-medium or can be implemented as hardware logic to execute the operation model 105 in the edge devices 103.

For example, the central server 102 can execute the decomposition instruction 107 to cause the operation model 105 to be divided into the portions 113, the input data 110 to be divided into the portions 114-1, 114-N of the input data, and to cause the portions 113 and portions 114-1, 114-N to be provided to the edge devices 103. The central server 102 can provide the portion 113-1 and the portion 114-1 to the edge device 103-1 and the portion 113-N and the portion 114-N to the edge device 103-N. The portions 114-1, 114-N can be referred to as portions 114. Each edge device from the edge devices 103 can receive a different one of the portions 114. In various instances, more than one edge device 103 can receive a same portion of the operation model 105 and/or the input data 110. For instance, a first edge device can receive a portion 113-1 while a second edge device and a third edge devices receive a portion 113-2.

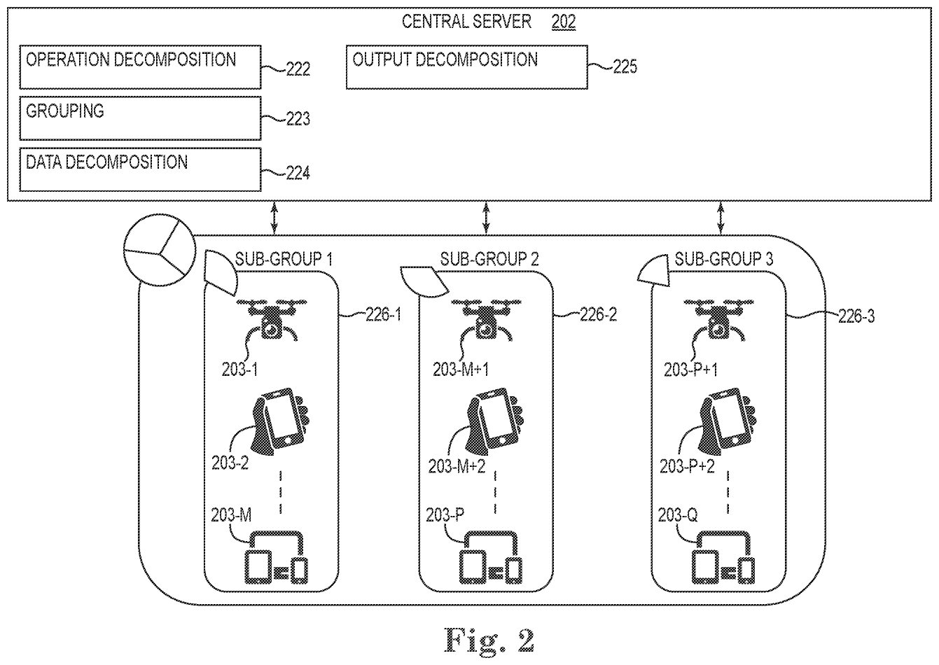

The edge devices 103 can provide portions 115 of the output data generated using the portions 113 of the operation model 105 to the central server 102. The central server can recompose (e.g., compose) to the portions 115 into the output data 106. In various examples the central server 102 can group the edge devices 103 into groups as shown in FIG. 2. The central server 102 can group the edge devices 103 into groups using the device data 112. The device data 112 can describe characteristics of the edge devices 103. The characteristics can include processing resources of the edge devices 103, memory resources of the edge devices 103, and/or connection resources that connects the edge devices 103 to the central server 102, for example.

In various examples, the processors 104 can be internal to the memory sub-systems 111 instead of being external to the memory sub-systems 111 as shown. For instance, the processors 104 can be processor in memory (PIM) processors. The processors 104 can be incorporated into the sensing circuitry of the memory sub-systems 111 and/or can be implemented in the periphery of the memory sub-systems 111, for instance. The processors 104 can be implemented under one or more memory arrays of the memory sub-systems 111.

FIG. 2 illustrates a block diagram for decomposing operations in accordance with some embodiments of the present disclosure. FIG. 2 includes a central server 202 and multiple groups (e.g., sub-groups) 226-1, 226-2, 226-3 referred to as groups 226, of edge devices 203-1, 203-2, 203-M, 203-M+1, 203-M+2, 203-P, 203-P+1, 203-P+2, 203-Q, referred to as edge devices 203. The central server 202 can store an operation. The central server 202 can store decomposition instructions which can comprise operation decomposition instructions 222, grouping instructions 223, data decomposition instructions 224, and output recomposition instructions 225, which can be referred to as instructions 222, 223, 224, 225, respectively. The instructions 222, 223, 224, 225 can be implemented as hardware and/or firmware. The instructions 222, 223, 224, 225 can be executed by a processor, such as processor 104-1 of FIG. 1.

Each of the groups 226 can comprise one or more edge devices 203. For example, the group 226-1 comprises edge devices 203-1, 203-2, 203-M. The group 226-2 comprises edge devices 203-M+1, 203-M+2, 203-P. The group 226-3 comprises edge devices 203-P+1, 203-P+2, 203-Q. The edge devices 203 are shown as including tablets, drones, cellular phones, mobile computing devices, and virtual reality (VR) headsets. The edge devices 203 can comprise different types of edge devices other than those shown herein.

The central server 202 can provide the operation model to the groups 226 by providing portions of the operation model to the groups 226. For instance, the central server 202 can provide a first portion of the operation model to the group 226-1, a section portion of the operation model to the group 226-2, and a third portion of the operation model to the group 226-3. Although the groups 226 are shown as comprising three groups, the groups 226 can comprise more or less than the three groups shown.

In various instances, each of the portions of the operation model can comprise sub-operation of the operation model. In some embodiments, the operation model can describe a multiplication operation performed using a matrix and a decimal value as an input. The portions of the operation model can describe the sub-operations utilized to multiply a matrix with a decimal value.

The operation decomposition instructions 222 can be executed by the central server 202 to decompose the operation model into the portions. The operation decomposition instructions 222 can utilize the quantity of groups 226 and the characteristics of the edge devices 203 to decompose the operation model into the portions. For example, edge devices 203-1, 203-2, 203-M of the group 226-1 can comprise a matrix multiplication unit. The operation decomposition instructions 222 can be executed to decompose the operation model into portions including a first portion that comprises matrix multiplication sub-operations. The central server 202 can provide the first portion to the group 226-1 given that the edge devices in the group 226-1 include matrix multiplication units that are capable of executing the matrix multiplication sub-operations. The characteristics of the edge devices 203 used to decompose the operation model can include processing capabilities of the edge devices 203, a connection speed between the central server 202 and the edge devices 203, and memory characteristics of the edge devices 203, among other characteristics of the edge devices 203 that can be used to decompose the operation model. In various instances, the quantity of the groups 226 can be used to determine a quantity portions into which the operation model is sub-divided.

Providing a portion of the operation model to the groups 226 of edge devices 203 can include providing a different instance of the same portion of the operation model to each of the edge devices 203 in a group. For example, providing the first portion of the operation model to the group 226-1 can include providing the first portion to the edge devices 203-1, 203-2, 203-M, such that each of the edge devices 203-1, 203-2, 203-M receives an instance (e.g., copy) of the first portion of the operation model. The central server 202 can provide the second portion to the edge devices 203-M+1, 203-M+2, 203-P, such that each of the edge devices 203-M+1, 203-M+2, 203-P receives an instance of the second portion of the operation model. The central server 202 can provide the third portion to the edge devices 203-P+1, 203-P+2, 203-Q, such that each of the edge devices 203-P+1, 203-P+2, 203-Q receives an instance of the third portion of the operation model.

The central server 202 can also provide input data to the groups 226 by providing a same instance of the input data to each of the edge devices 203 in the groups 226 or by providing different portions of the input data to the edge devices 203. The central server 202 can decompose the input data. For example, the central server 202 can divide the input data into multiple portions. In various instances, decomposing the input data can include providing portions of the input data where the portions include duplicate data. For example, a first portion and a second portion can include a same value that was provided a single time in the input data prior to decomposition. For instance, if the input data comprises a 10×10 matrix, then the input data can be decomposed into four 6×6 matrices where more than one of the 6×6 matrices share a data value that was included in the 10×10 matrix.

The central server 202 can decompose the input data based on properties of groups 226 and/or properties of the edge devices 203. For instance, the quantity of portions that comprise the input data can coincide with the quantity of groups 226. The portions can also be generated based on the processing capabilities of the edge devices 203 and/or the memory capabilities of the edge devices 203. For example, a size of the properties can be equal to or smaller than the capacity of the memory of the edge devices 203.

The central server 202 can provide the portions of the operation model to the groups 226 concurrently. The central server 202 can concurrently provide a same portion of the operation model to each of the edge devices 203 in the group 226-1. The central server 202 can provide the input data to the groups 226 concurrently. The central server 202 can concurrently provide a same portion of the input data to each of the edge devices 203 in the group 226-1. As used herein, data can be provided concurrently by providing said data to multiple devices at relatively the same time. Data can be processed concurrently by processing the data at relatively the same time. The edge devices 203 can process the input data using the operation model concurrently. For instance, the edge devices 203-1, 203-2 can process a first portion of the input data concurrently using the first portion of the operation model.

The edge devices 203 can generate outputs that can be provided to the central server 202. For instance, the edge device 203-1 can generate a first output, the edge device 203-2 can generate a second output, the edge device 203-M can generate an Mth output. The edge devices 203 can concurrently provide the outputs to the central server 202.

The central server 202, using the output recomposition instructions 225, can recompose the outputs provided by the edge devices 203 to generate an output for the operation model. For instance, the first output, the second output, and the Mth output generated by the edge devices in the group 226-1 can be combined to generate a single output for the first portion of the operation model. An M+1 output, an M+2 output, and a P output generated by the edge devices in the group 226-2 can be combined to generate a single output for the second portion of the operation model. A P+1 output, a P+2 output, and a Q output generated by the edge devices in the group 226-3 can be combined to generate a single output for the third portion of the operation model.

In various instances, the outputs of the groups 226 can be recomposed by applying an operation to combine the outputs into a single output. For example, the outputs can be averaged to generate a single output. A minimum or a maximum of the outputs can be selected as the single output for a portion of the operation model, among other possible operations that can be applied to the outputs. In various instances, the outputs can be multiple matrices and the single output can be a single matrix. The outputs can be multiple classification from an ANN and the single output can be a single classification from the ANN. In various instances, recomposing can comprise aggregating. For example, the outputs can be aggregated to generate a single output.

Once the single output for each of the portions of the operation model is generated, the central server 202 can recompose the single outputs to generate an output for the operation model. For instance, a first output for the first portion of the operation model, a second output for the second portion of the operation model, and a third portion of the operation model can be recomposed to generate an output for the operation model.

In various examples, the edge devices 203 can be grouped based on characteristics of the edge devices 203 which can be beneficial for the performance of the operation model. For example, the edge devices 203 in a geographical location can be grouped together and/or edge devices 203 of different computing capabilities can be grouped together. Grouping edge devices 203 of different computing capabilities can provide for diverse sets of outputs which can contribute to confidence in generating an output for the operation model.

The edge devices 203 can be grouped based on the edge devices' ability to receive matrices having a particular dimension and based on the edge devices' ability to process the received matrices utilizing a corresponding portion of operation model. For example, the edge devices 203-M+1,203-M+2, 203-P can be grouped based on their ability to receive 10×10 matrices and based on their ability to process the received matrices to generate an output. The edge device 203-Q may not be included in the group 226-2 given that the edge device 203-Q may be incapable of processing the matrices (e.g., 10×10 matrices) received from the central server 202.

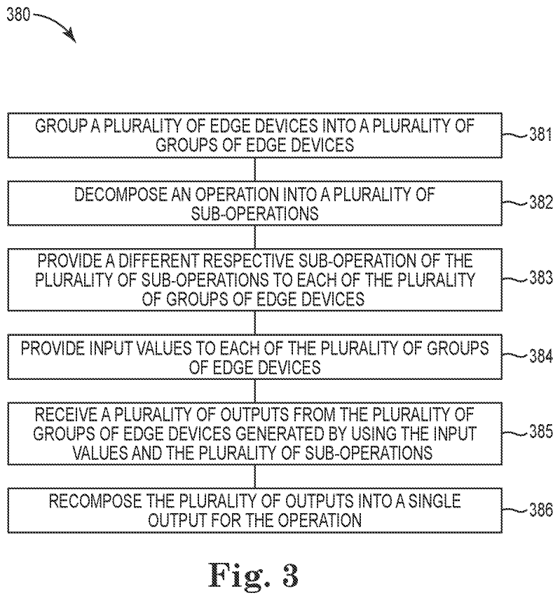

FIG. 3 is a flow diagram corresponding to a method 330 for decomposing operations in accordance with some embodiments of the present disclosure. The method 330 may be performed, in some examples, using a computing system such as those described with respect to FIG. 1. The method 330 can be used to decompose operation using edge devices.

At 381, a plurality of edge devices can be grouped into a plurality of groups of edge devices. The edge devices can be grouped based on the characteristics of the edge devices. At 382, an operation can be decomposed into a plurality of sub-operations. The operation can be decomposed based on the characteristics of the edge devices. At 383, a different respective sub-operation of the plurality of sub-operations can be provided to each of the plurality of groups of edge devices. For example, a first sub-operation can be provided to a first group, a second sub-operation can be provided to a second group, and a third sub-operation can be provided to a third group.

At 384, input values can be provided to each of the plurality of groups of edge devices. For example, a first input value can be provided to a first group, a second input value can be provided to a second group, and a third input value can be provided to a third group. At 385, a plurality of outputs can be received from the plurality of groups of edge devices generated by using the input values and the plurality of sub-operations. For example, the central server can receive a first output from a first edge device of a group and a second output from the second edge device of the group. At 386, the plurality of outputs can be recomposed into a single output for the operation. For example, a first number of outputs received from a first group can be aggregated into a first output, a second number of outputs received from a second group can be aggregated into a second output, and a third number of outputs received from a third group can be aggregated into a third output. The first output, the second output, and the third output can be recomposed into a single output which can be an output of the operation model in view of the input.

The plurality of edge devices can be grouped by dividing the plurality of edge devices into groups based on characteristics of the edge devices. The characteristics of the edge devices can include processing capabilities of the edge devices, memory capabilities of the edge devices, among other characteristics of the edge devices. The plurality of sub-operations can be provided to the plurality of groups. For example, a same sub-operation or a plurality of sub-operations can be provided to each edge device in a group. Different sub-operations can be provided to different groups.

The edge devices can generate outputs can provide the outputs, via a network coupling the edge devices to the central server, to the central server. The central server can receive multiple outputs from edge devices in a group and can generate a single output from the multiple outputs. The single output can correspond to a sub-operation provided to the group of edge devices and/or the group of edge devices. A single output can be received for each of the groups such that there are multiple single outputs. The single outputs received from the groups can be referred to as single group outputs. A single group output can be generated from the outputs provided by the edge deices in a group. The single group outputs can be recomposed into a single output for the operation model. In various instances, the recomposing of the outputs can be linked to the decomposing of the operation model. For example, the decomposition of the operation model can comprise an order for the sub-operation. The order can include an order in which the sub-operation are executed and/or an order in which the sub-operations receive the inputs. The outputs can be recomposed in an inverse order in which the operation model was decomposed. For example, the plurality of outputs can be arraigned in an inverse order from which the operation was divided.

In various instances, an operation can be decomposed into a plurality of portions of the operation. The portions can be sub-operations. The sub-operations can be performed by a processing resource of the edge devices and/or memory sub-systems of the edge devices. For example, a processing resource of a memory sub-system can perform the sub-operations. The sub-operations can include memory access operations. In various instances, the sub-operations can include network operations including an edge device providing data and/or commands to a different edge devices. The sub-operations can include operations performed by a graphical processing unit (GPU) and/or operations that are performed by an auxiliary device of an edge device such as operations performed by a camera.

A different portion from the plurality of portions can be provided to each group of a plurality of groups of edge devices. For example, a first portion can be provided to edge devices in a first group and a second portion can be provided to edge devices in a second group. The first portion and the second portion can be different devices.

The input values can be provided to each of the plurality of groups of edge devices. For example, a first portion of the input values can be provided to edge devices in a first group and a second portion of the input values can be provided to edge devices in a second group. In various instances, the input values can be provided to each group such that each of the edge devices in the plurality of groups receive the input values.

The central server can receive a plurality of outputs from the plurality of groups of edge devices. The outputs can be generated using the input values and the plurality of portions of the operation model. Each of the edge devices can provide an output value to the central server. The central server can recompose the plurality of output values into a single output for the operation.

The operation can be decomposed into a plurality of portions based on a quantity of the plurality of groups and/or the edge devices (e.g., characteristics of the edge devices) in each of the plurality of groups. For example, the operation can be decomposed based on memory characteristics of the edge devices. Decomposing the operation can include dividing the operation into a plurality of sub-operations which comprise the portions. In various example, the operation can be divided into the plurality of sub-operations based on whether the edge devices in each of the plurality of groups of edge devices have a matrix multiplication unit (MMU). For example, matrix multiplication operation can be divided from the operation and can be provided to a first group that comprises an MMU. The operation can be divided based on a connection speed coupling edge devices of the plurality of groups of edge devices. For example, sub-operation that are implemented using large amounts of input data may be divided and provided to edge devices that have a high bandwidth connection with a central server. The high bandwidth connection being able to transfer the large amounts of input data in a timely manner needed to perform the sub-operation.

In various instances, a plurality of edge devices can be grouped into a plurality of groups of edge devices. An operation can be decomposed into a plurality of sub-operations. Each of the plurality of sub-operations of the operation can be provided to a different group of edge devices from the plurality of groups of edge devices. Input values can be decomposed into a plurality of portions of the input values. The decomposition of input values can correspond to the decomposition of the operation. The plurality of portions of the input values can be provided to each of the plurality of groups of edge devices. The central server can receive a plurality of outputs from the plurality of groups of edge devices generated using the plurality of portions of the input values and the plurality of sub-operations. The plurality of outputs can be recomposed into a single output for the operation.

The input values can be decomposed into the plurality of portions based on characteristics of a plurality of edge devices of the plurality of groups. The characteristics of the edge devices can include a memory size of the plurality of edge devices. A different portion from the plurality of portions of the input values can be provided to each of the plurality of groups of edge devices. The different portion can include a first matrix and a second matric. In various instances, the different portion can include a matrix and a value, for example.

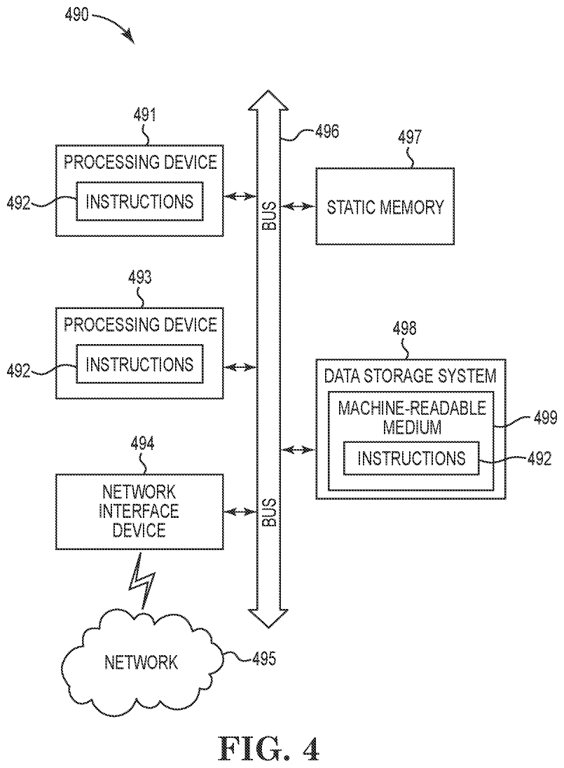

FIG. 4 is a block diagram of an example computer system 490 in which embodiments of the present disclosure may operate. For example, FIG. 4 illustrates an example machine of a computer system 490 within which a set of instructions, for causing the machine to perform any one or more of the methodologies discussed herein, can be executed. In some embodiments, the computer system 490 can correspond to a host system that includes, is coupled to, or utilizes a memory sub-system (e.g., the memory sub-systems 111-1, 111-2, 111-N+1 of FIG. 1). The computer system 490 can be used to perform the operations described herein (e.g., to perform operations corresponding to the processors 104-1, 104-2, 104N+1 of FIG. 1). In alternative embodiments, the machine can be connected (e.g., networked) to other machines in a LAN, an intranet, an extranet, the Internet, and/or wireless network. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 490 includes a processing device (e.g., processor) 491, a main memory 493 (e.g., read-only memory (ROM), flash memory, dynamic random access memory (DRAM) such as synchronous DRAM (SDRAM) or Rambus DRAM (RDRAM), etc.), a static memory 497 (e.g., flash memory, static random access memory (SRAM), etc.), and a data storage system 498, which communicate with each other via a bus 496.

The processing device 491 represents one or more general-purpose processing devices such as a microprocessor, a central processing unit, or the like. More particularly, the processing device 491 can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device 491 can also be one or more special-purpose processing devices such as an application specific integrated circuit (ASIC), a field programmable gate array (FPGA), a digital signal processor (DSP), network processor, or the like. The processing device 491 is configured to execute instructions 492 for performing the operations and steps discussed herein. The computer system 490 can further include a network interface device 494 to communicate over the network 495.

The data storage system 498 can include a machine-readable storage medium 499 (also known as a computer-readable medium) on which is stored one or more sets of instructions 492 or software embodying any one or more of the methodologies or functions described herein. The instructions 492 can also reside, completely or at least partially, within the main memory 493 and/or within the processing device 491 during execution thereof by the computer system 490, the main memory 493 and the processing device 491 also constituting machine-readable storage media. The machine-readable storage medium 499, data storage system 498, and/or main memory 493 can correspond to the memory sub-systems 111-1, 111-2, 111-N+1 of FIG. 1.

In one embodiment, the instructions 492 include instructions to implement functionality corresponding to mirroring data to a virtual environment (e.g., using processors 104-1, 104-2, 104-N+1 of FIG. 1). While the machine-readable storage medium 499 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. An apparatus comprising:
a processing device configured to:
decompose an operation into a plurality of portions of the operation;
provide a different portion from the plurality of portions to each group from a plurality of groups of edge devices;
provide input values to each of the plurality of groups of edge devices;
receive a plurality of outputs from the plurality of groups of edge devices generated using the input values and the plurality of portions; and
recompose the plurality of outputs into a single output for the operation.

2. The apparatus of claim 1, wherein the processing device is further configured to decompose the operation into the plurality of portions based on a quantity of the plurality of groups.

3. The apparatus of claim 1, wherein the processing device is further configured to decompose the operation into the plurality of portions based on edge devices in each of the plurality of groups.

4. The apparatus of claim 1, wherein the processing device is further configured to decompose the operation by dividing the operation into a plurality of sub-operations which comprise the plurality of portions.

5. The apparatus of claim 4, wherein the processing device is further configured to divide the operation into the plurality of sub-operations based on characteristics of edge devices in each of the plurality of groups of edge devices.

6. The apparatus of claim 5, wherein the processing device is further configured to divide the operation into the plurality of sub-operations based on whether edge devices in each of the plurality of groups of edge devices have a matrix multiplication unit.

7. The apparatus of claim 5, wherein the processing device is further configured to divide the operation into the plurality of sub-operations based on a connection speed coupling edge devices of the plurality of groups of edge devices and the apparatus.

8. The apparatus of claim 4, wherein the processing device is further configured to provide a different sub-operation from the plurality of sub-operations to each group from the plurality of groups of edge devices.

9. The apparatus of claim 4, wherein the processing device is further configured to provide a same sub-operation to each of the edge devices in a group from the plurality of groups of edge devices.

10. A method comprising:
grouping a plurality of edge devices into a plurality of groups of edge devices;
decomposing an operation into a plurality of sub-operations;
providing a different respective sub-operation of the plurality of sub-operations to each of the plurality of groups of edge devices;
providing input values to each of the plurality of groups of edge devices;
receiving a plurality of outputs from the plurality of groups of edge devices generated by using the input values and the plurality of sub-operations; and
recomposing the plurality of outputs into a single output for the operation.

11. The method of claim 10, wherein grouping the plurality of edge devices further comprises dividing the plurality of edge devices into groups based on characteristics of the edge devices.

12. The method of claim 10, wherein providing the different respective sub-operation to each of the plurality of groups of edge devices further comprises providing a same sub-operation to each edge device in a particular group from the plurality of groups.

13. The method of claim 10, further comprising generating a respective single group output for each of the plurality of groups.

14. The method of claim 13, wherein recomposing the plurality of outputs into the single output further comprises recomposing the respective single group outputs into the single output.

15. The method of claim 10, wherein recomposing the plurality of outputs into a single output further comprises arraigning the plurality of outputs in an inverse order from which the operation was divided.

16. A non-transitory machine-readable medium having computer-readable instructions, which when executed by a computer, cause the computer to:
group a plurality of edge devices into a plurality of groups of edge devices;
decompose an operation into a plurality of sub-operations;
provide a respective sub-operation from the plurality of sub-operations to a each of the plurality of groups of edge devices;
decompose input values into a plurality of portions of the input values;
provide the plurality of portions of the input values to each of the plurality of groups of edge devices;
receive a plurality of outputs from the plurality of groups of edge devices generated using the plurality of portions of the input values and the plurality of sub-operations; and
recompose the plurality of outputs into a single output for the operation.

17. The machine-readable medium of claim 16, wherein the instructions are further executable to decompose the input values into the plurality of portions based on characteristics of a plurality of edge devices of the plurality of groups.

18. The machine-readable medium of claim 17, wherein the characteristics of the plurality of edge devices include a memory size of the plurality of edge devices.

19. The machine-readable medium of claim 17, wherein the instructions are further executable to provide a different portion from the plurality of portions of the input values to each of the plurality of groups of edge devices.

20. The machine-readable medium of claim 19, wherein the different portion includes a first matrix and a second matric.

21. The machine-readable medium of claim 19, wherein the different portion includes a matrix and a value.
